(19) United States
(12) Patent Application Publication
(10) Pub. No.: US 2005/0122837 A1
(43) Pub. Date: Jun. 9, 2005

(54) Blender jar

(75) Inventors: Annette D. Bravard, Pleasant Hill, IA (US); Brian K. Linstedt, Ostrander, OH (US); Joshua D. Dickman, Powell, OH (US)

Correspondence Address: MCKEE, VOORHEES & SEASE, P.L.C.;ATTN: MAYTAG, 801 GRAND AVENUE, SUITE 3200, DES MOINES, IA, 50309-2721, US

(73) Assignee: Maytag Corporation, Newton, IA (US)

(21) Appl. No.: 10/729,713

(22) Filed: Dec. 5, 2003

(51) Int. Cl. B01F 7/00

(52) U.S. Cl. 366/199; 366/205

(57) ABSTRACT

An improved blender jar is provided for an electric blender. The blender includes a base with a motor. The jar includes a body with opposite upper and lower ends. The lower end has a collar adapted to mount onto the base such that a knife mounted in the lower end of the jar is coupled with the output shaft of the motor for rotation by the motor. The body of the jar has a reduced cross-sectional area portion between the upper and lower ends so as to enhance blending action of materials in the jar. The body also has inwardly extending ribs to enhance blending.

### BACKGROUND OF THE INVENTION

Blenders are well-known for blending foods or drinks. A conventional blender generally include a base with a motor therein, a plastic or glass container or jar mounted on the base with a knife rotatably driven by the motor, a lid for the jar, and control switches or buttons to control the speed of the motor. The jars normally are a constant diameter along their height, or increase in diameter from bottom to top. These shapes of the blender jar allow food items to bridge adjacent the bottom of the jar, such that the knife cavitates without blending the food items. The normal solution to this cavitation problem is to remove the lid of the jar, and shove the food items downwardly with a spatula, wooden spoon, or other object.

Therefore, a primary objective of the present invention is the provision of an improved blender jar which enhances blending of food and drink materials.

Another objective of the present invention is the provision of an improved blender jar which eliminates the blade cavitation problem of the prior art blenders.

Another objective of the present invention is the provision of a blender jar that circulates the food or drink items being blended.

A further objective of the present invention is the provision of a blender jar having a reduced cross-sectional area portion between the bottom and top ends of the jar so as to provide a circular flow path of materials being blended.

Yet another objective of the present invention is the provision of a blender jar having internal ribs to enhance blending of food and drink materials.

Still another objective of the present invention is the provision of a blender jar having an aesthetically pleasing appearance.

These and other objectives will become apparent from the following description of the invention.

### SUMMARY OF THE INVENTION

The blender jar of the present invention is adapted to be mounted on a blender base which houses a motor, with a knife positioned in the bottom of the jar for rotation by the motor. The jar includes a body having opposite upper and lower ends, with the lower end being adapted to be mounted onto the base. The body curves outwardly from the lower end and then inwardly so as to define a reduced cross-sectional area portion between the upper and lower ends. The body again curves outwardly adjacent the upper end of the jar. The jar has internal ribs to enhance the blending action of food and drink materials in the jar. A lid is provided to close the upper end of the jar. The jar includes a handle for easy gripping by a user.

### BRIEF DESCRIPTION OF THE DRAWINGS

FIG. 1 is a perspective view of the blender with the jar of the present invention mounted thereon.

FIG. 2 is a front elevation view of the blender.

FIG. 3 is a top plan view of the blender.

FIG. 4 is a sectional view of the blender jar taken along lines 4-4 of FIG. 2 (background omitted) to display the cross-sectional area of the blender jar at this horizontal plane.

### DETAILED DESCRIPTION OF THE PREFERRED EMBODIMENT

The blender jar of the present invention is generally designated by the reference numeral 10. The jar 10 includes a body 12 with a lower or first end 14 and an upper or second end 16. A handle 18 is provided on the body for gripping by a user. The upper end 16 includes a pouring spout 20 opposite the handle 18. The lower end 14 is threaded to receive a mounting collar or ring 22. A knife 24 with a plurality of blades 25a, b, c, d is rotatably mounted in the jar 10. A sealing ring (not shown) is provided in the collar 22 to provide sealing engagement with the bottom of the jar 10 when the collar 22 is tightened on the jar 10. A lid 26 closes the upper end 16 of the jar 10.

The jar 10 is adapted to mount on a base 28 which houses an electric motor (not shown). The motor is variable speed, with the speed of the motor being controlled by buttons on a keypad 32. The motor includes an output shaft 34 extending upwardly through base 28. An electrical connection block 30 is included in base 28 for connecting a detachable power cord (not shown). The collar 22 includes threads for threadably mounting the assembled jar 10 and collar 22 onto mating threads on the upper end of the base 28, so that the knife 24 is drivingly connected to the shaft 34 for rotation by the motor. The user then selects a speed for the motor by pressing one of the buttons or sensors on the keypad 32, as in a conventional blender, to actuate the motor and thereby turn the knife 24. The driving connection between the motor and the knife 24 is conventional and does not constitute part of the present invention.

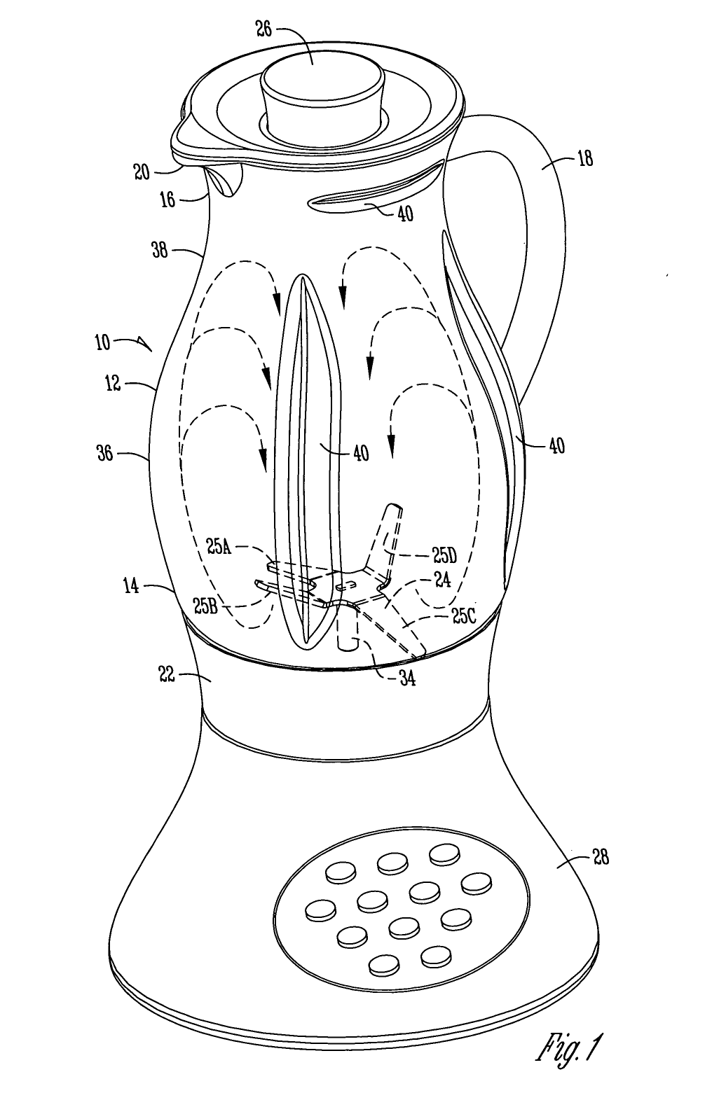

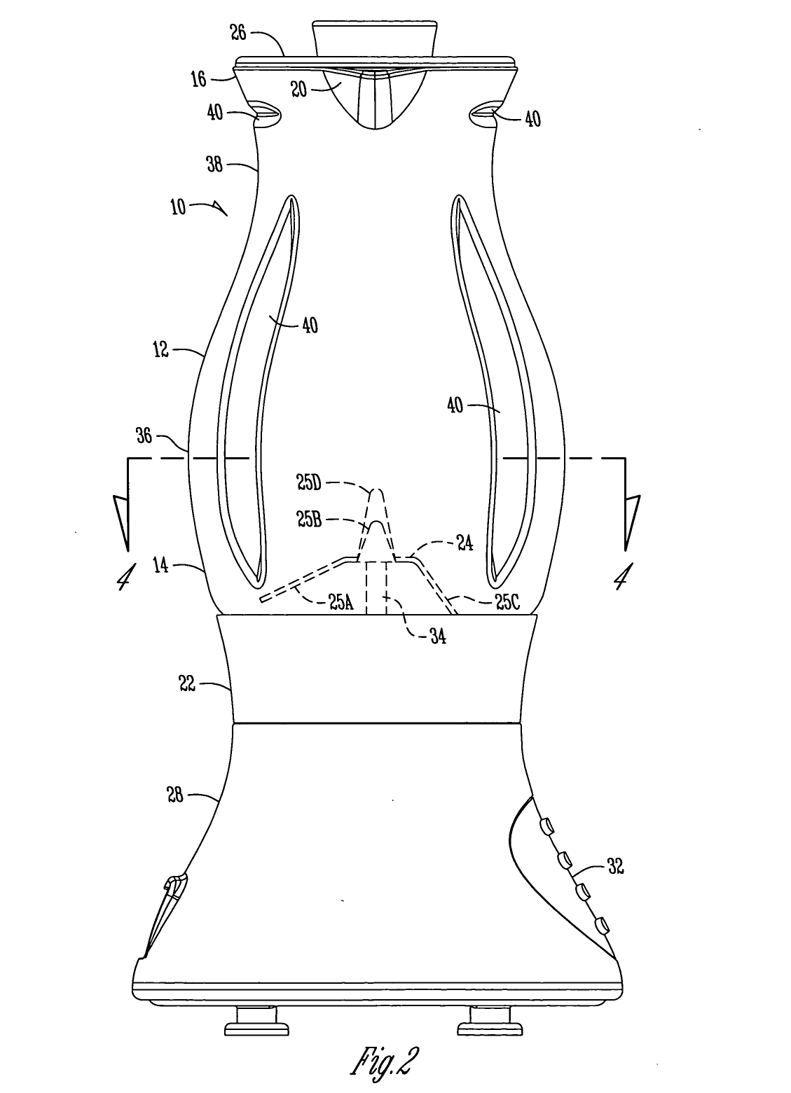

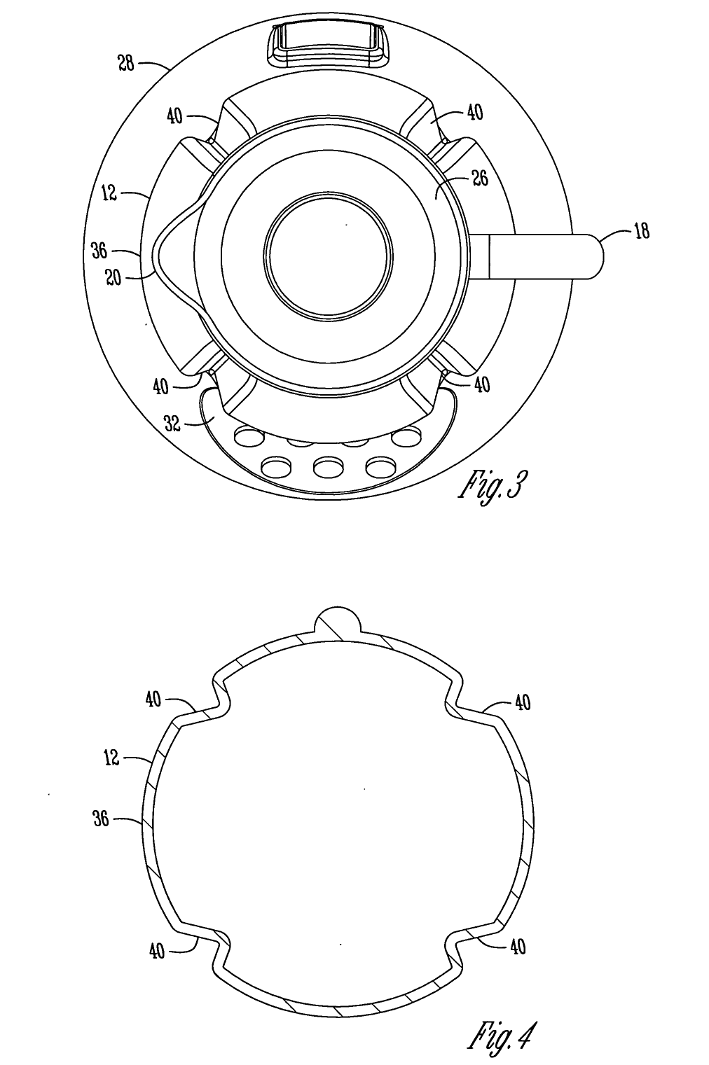

The body 12 of the jar 10 has a curved wall or profile, as seen in FIGS. 1 and 2. Preferably, the body 12 curves outwardly from the lower end 14 to define an increased cross-sectional area portion 36, and then curves inwardly to define a reduced cross-sectional area portion 38. The body 12 also has inwardly extending, longitudinal ribs 40. It is understood that the shape of the ribs may vary from that shown in the figures.

For purposes of definition, the cross-sectional area, or more simply, the area of the blender jar is defined at various elevations by cross-sectional views that cut the jar on a horizontal plane. One such cross-section is indicated in FIG. 2 along the lines 4-4.

The blades of the knife 24 extend at various angles from a horizontal plane, both upwardly and downwardly, as seen in FIGS. 1 and 2. Blade 25a extends the furthest from the shaft 34 and defines a spinning diameter of the knife 24. The spinning diameter of the knife 24 is at least substantially equal to the diameter of the reduced portion 38. This relationship between the spinning blade diameter and the jar diameter enhances the performance of the blender.

In operation, food or drink items are placed into the jar 10 while the motor is off. The lid 26 is then fit into the upper end 16 of the jar 10 to seal the jar. As the knife 24 turns, the materials in the jar 10 are chopped up and blended. The rotating knife 24 imparts a flow path to the materials upwardly along the inner wall of the jar 10. The reduced cross-sectional area portion 38 of the body 12 directs the material towards the center axis of the jar, where the materials fall downwardly for further blending by the knife 24. Thus, the materials being blended have a circular flow path, as indicated by the arrows in the drawings. This circular flow path enhances the blending action in the jar 10 and eliminates cavitation of the food items. The ribs 40 tend to break up the flow of material around the inside of the jar 10 which is imparted by the rotating knife 24, so as to enhance blending. When the desired blending has been achieved, an “off” button on the keypad 32 is pushed to deactuate the motor and stop rotation of the knife 24. The jar 10 can then be removed from the base 28, and the lid 26 removed from the jar 10 so that the blended contents can be poured out via the spout 20.

The invention has been shown and described above with the preferred embodiments, and it is understood that many modifications, substitutions, and additions may be made which are within the intended spirit and scope of the invention. For example, the preferred embodiment has been described with a cross-sectional area that is, disregarding ribs 40, approximately circular. However, it should be understood all possible cross-sectional area shapes are within the scope of the present invention. From the foregoing, it can be seen that the present invention accomplishes at least all of its stated objectives.

1. A blender jar for use on an electric blender having a base with a motor, and a knife rotatable by the motor, the jar comprising:
a body having first and second opposite ends; and
the body having a reduced cross-sectional area portion spaced from the first end to enhance blending action in the jar.

2. The blender jar of claim 1 wherein the body increases in cross-sectional area upwardly from the first end.

3. The blender jar of claim 2 wherein the body increases in cross-sectional area upwardly from the reduced cross-sectional area portions.

4. The blender jar of claim 1 wherein the body increases in cross-sectional area upwardly from the reduced cross-sectional area portions.

5. The blender jar of claim 1 wherein the body has a curved profile.

6. The blender jar of claim 1 wherein the body curves outwardly and then inwardly from the first end to the second end.

7. The blender jar of claim 1 wherein the body includes a handle.

8. The blender jar of claim 1 further comprising a plurality of ribs extending inwardly in the body of the jar.

9. The blender jar of claim 1 wherein the shape of the cross-sectional area is generally circular.

10. A blender jar for a blender having a base, a motor in the base, and a knife driven by the motor, the jar comprising:
a body having first and second opposite ends,, the first end being adapted to mount onto the base; and
the body curving outwardly and then curving inwardly between the first end and the second end.

11. The blender jar of claim 10 wherein the inward curve defines a portion having a reduced cross-sectional area.

12. The blender jar of claim 10 wherein the body curves outwardly adjacent the second end.

13. The blender jar of claim 10 wherein the body includes a handle.

14. The blender jar of claim 10 further comprising a plurality of ribs extending inwardly in the body of the jar.

15. A blender jar for a blender having a base, a motor in the base, and a knife driven by the motor, the jar comprising:
a body having opposite first and second ends, the first end being adapted to mount onto the base;
the body having a reduced cross-sectional area portion spaced from the first end; and
a plurality of ribs extending inwardly in the body to enhance blending.

16. The blender jar of claim 15 wherein the body has a curved profile.

17. The blender jar of claim 15 wherein the body curves outwardly and then inwardly from the first end to the second end.

18. The blender jar of claim 15 wherein the body includes a handle.

19. A blender jar for use with a blender, the blender jar comprising:
a body having first and second opposite ends and an intermediate portion; and
the body having a generally circular cross-sectional area between the first and second ends, the first and second ends having first and second diameters and the intermediate portion having another diameter larger than either of the first or second diameters, the first and second ends being interconnected with the intermediate portion to define an outwardly and then an inwardly curved profile therebetween.

20. The blender jar of claim 19 wherein the body includes a handle.

21. The blender jar of claim 19 further comprising a plurality of ribs extending inwardly in the body of the jar.

22. The blender jar of claim 19 wherein the shape of the cross-sectional area is generally circular.

23. A blender, comprising:
a base;
a jar mounted on the base and having a body with a reduced cross-sectional area spaced above the base;
a motor in the base with a rotatable output shaft extending upwardly into the jar;
a plurality of blades mounted on the motor output shaft for rotation in the jar, the blades defining a spinning diameter when rotating which is at least substantially equal to a diameter of the reduced cross-sectional area of the jar.

24. The blender of claim 23 wherein the jar has upper and lower ends with a curved profile therebetween.

25. The blender of claim 23 wherein the jar profile extends outwardly from the lower end, then inwardly and then outwardly adjacent the upper end.

26. The blender of claim 24 wherein the body has a plurality of internal ribs.

27. The blender of claim 24 wherein the body has a generally circular cross-sectional shape between the upper and lower ends.
